(19) United States
(12) Patent Application Publication
(10) Pub. No.: US 2025/0389526 A1
(43) Pub. Date: Dec. 25, 2025

(54) Magnetic Sensing Electronic Tape Measure

(71) Applicant: Guangdong Welland Technology Co., Ltd., Zhongshan City, Guangdong (CN)

(72) Inventor: Rui Jun Gao, Zhongshan (CN)

(21) Appl. No.: 18/578,097

(22) PCT Filed: Jun. 9, 2023
(86) PCT No.: PCT/CN2023/099417

§ 371 Date: Apr. 16, 2025

(30) Foreign Application Priority Data
May 30, 2023 (CN) 202310626488.8

(51) Int. Cl. G01B 3/1056; G01B 3/1005; G01D 5/14

(52) U.S. Cl. CPC G01B 3/1056; G01B 3/1005; G01D 5/145; G01B 2003/103

(57) ABSTRACT

The present invention discloses a magnetic sensing electronic tape measure comprising a housing, a reel within the housing, and a tape wound onto the reel, characterized in that: a magnet is fixed to the reel, and a magnetic sensor module within the housing senses the rotation of the magnet. Through the magnet, an external magnetic field will be applied to the magnetic sensor module. When the tape is pulled out, the reel and the magnet rotate. The magnetic sensor module can sense the change in direction of the external magnetic field and convert this change into a change in tape length. As a result, the length of the extracted tape, and thus the length of a measured target, can be determined.

### FIELD OF INVENTION

The present invention relates to a tape measure, in particular to a magnetic sensing electronic tape measure.

### BACKGROUND OF THE PRESENT INVENTION

Tape measures are prevalent tools for measuring in daily life and work. The majority of available tape measures are made of steel. However, as society has progressed, digital tape measures have been introduced to provide users with more convenient and direct observation of measurement data. These digital variants use capacitive grid sensors as their basic technology and derive length measurements by calculating the angular changes through these sensors. The principle is as follows: the capacitive grid sensor consists of upper and lower electrodes; by measuring the capacitive changes between these electrodes, the angle changes are calculated.

However, capacitive grid sensors are characterized by their complex mounting structures and significant susceptibility to temperature fluctuations, which can adversely affect the accuracy of measurement results. Conversely, magnetic sensors offer a more streamlined mounting process and exhibit greater resistance to temperature variations and reduced effects of aging.

Consequently, the applicant has developed a magnetic sensing electronic tape measure to mitigate these challenges.

### SUMMARY OF THE PRESENT INVENTION

To overcome the shortcomings of the existing technology, the present invention provides a magnetic sensing electronic tape measure.

The technical solution adopted by the present invention to solve its technical problem is as follows:

A magnetic sensing electronic tape measure, comprising a housing, a reel mounted within the housing, and a tape wound onto the reel, characterized in that: a magnet is fixed on the reel, and a magnetic sensor module capable of sensing the rotation of the magnet is provided within the housing.

The magnet is a disc-shaped magnet, and the center of the magnet is coaxial with the rotational center of the reel.

The structure further comprises a mounting plate, with the magnet fixed in the mounting plate and the mounting plate fixed to the reel.

The housing is formed with a recess and an axial hole communicating with the recess. The mounting plate is located in the recess with a mounting through-hole at the bottom center. The reel is equipped with a rotating shaft, which is connected to the axial hole through a bearing. The rotating shaft is provided with a fixed screw hole, a fixing screw passes through the mounting through-hole and is fixed to the fixed screw hole, thereby fixing the mounting plate to the rotating shaft.

The reel comprises an inner flange and an outer flange. The rotating shaft is disposed on the inner flange, and the inner flange is disposed within a flange hole of the outer flange and is secured to the outer flange by a snap-fit structure. A spiral spring is mounted in a space isolated by the inner flange within the flange hole.

The housing comprises an upper housing and a lower housing.

The end of the tape is equipped with an end magnet, and the housing is equipped with a Hall switch for sensing the end magnet.

The end magnet is cylindrical, with an annular recess in the center. The end of the tape is rolled into a cylinder, and the cylinder fits into the annular recess.

The beneficial effects of the present invention are as follows: By mounting the magnet on the reel and providing the magnetic sensor module capable of sensing the rotation of the magnet within the housing. Through the magnet, an external magnetic field will be applied to the magnetic sensor module. When the tape is pulled out, the reel rotates and the magnet rotates accordingly. The magnetic sensor module can sense the change in direction of the external magnetic field and convert the change in direction into change data of the tape length. As a result, the length of the extracted tape, and thus the length of a measured object, can be determined. Hence, the application of magnetic sensors in tape measures not only provides a more streamlined mounting process compared with the previous capacitive grid sensors, but also exhibits greater resistance to temperature variations and reduces the effects of aging, as well as providing higher sensitivity.

### BRIEF DESCRIPTION OF THE DRAWINGS

The present invention is further illustrated below in conjunction with the drawings and embodiments:

FIG. 1 is an assembly structure diagram of the present invention after removal of the outer shell; and

FIG. 2 is an exploded structure diagram of the present invention after removal of the outer shell.

### DETAILED DESCRIPTION OF THE PREFERRED EMBODIMENTS

The advantages, features, and methods of implementation of the disclosure will be illustrated by the following embodiments described with reference to the accompanying drawings. However, the disclosure may be embodied in various forms and should not be construed as limited to the embodiments described herein. Rather, these embodiments are provided to ensure that the disclosure is thorough and complete and to fully convey the scope of the disclosure to those skilled in the art. Moreover, the disclosure is defined solely by the scope of the claims.

The shapes, sizes, proportions, angles, and numbers shown in the drawings used to describe the embodiments of the disclosure are only exemplary, and therefore the disclosure is not limited to the details shown. Throughout the specification, the same reference numbers indicate the same elements. Detailed descriptions of known features or configurations determined to unnecessarily obscure the focus of the disclosure will be omitted. The terms “comprising,” “having,” and “including” as used in the description of this document, unless otherwise indicated as “exclusive,” permit the addition of other elements. Unless otherwise indicated, singular terms may include the plural.

When interpreting elements, it should be understood that elements include a margin of error, even if it is not explicitly described.

When describing spatial relationships, for example, when describing position as “on”, “above”, “below”, and “adjacent to” one or more parts may be arranged between two other parts unless “immediately” or “directly” is used.

When describing temporal relationships, for example, when describing the sequence as “after”, “subsequently”, “next”, and “before”, discontinuities may be included unless “exactly” or “directly” is used.

It should be understood that although terms such as “first”, “second”, etc. may be used herein to describe various elements, these elements should not be limited by these terms. These terms are used only to distinguish one element from another. For instance, a first element may be termed a second element, and similarly, a second element may be termed a first element, without departing from the scope of the disclosure.

As those skilled in the art will fully appreciate, the features of different embodiments of the disclosure may be partially or fully coupled or assembled with each other, and may be technically driven and interact with each other in various ways. The embodiments of the disclosure may be implemented independently of each other, or may be implemented in a mutually dependent relationship.

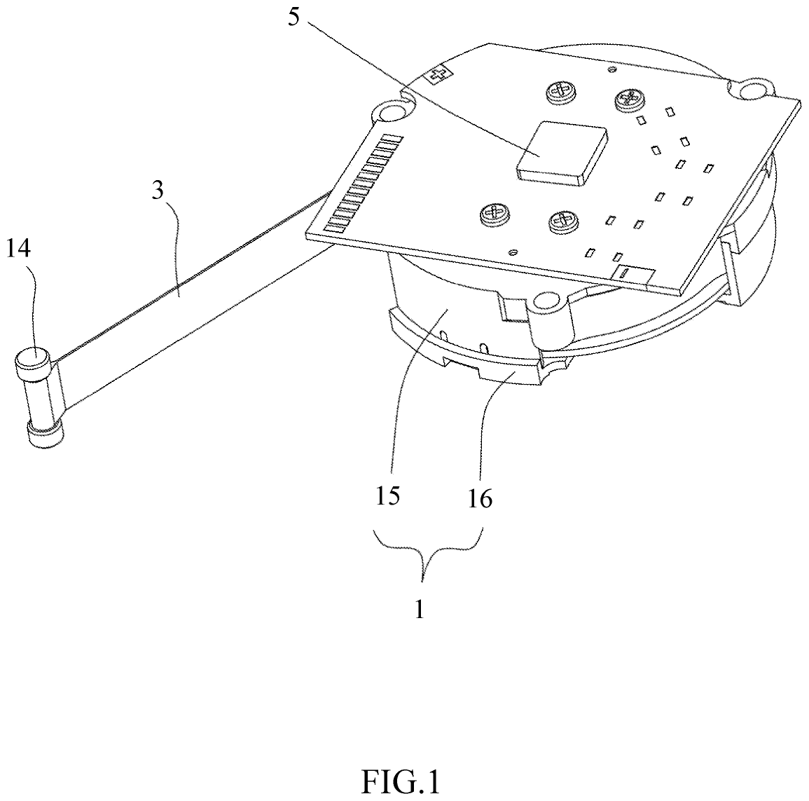

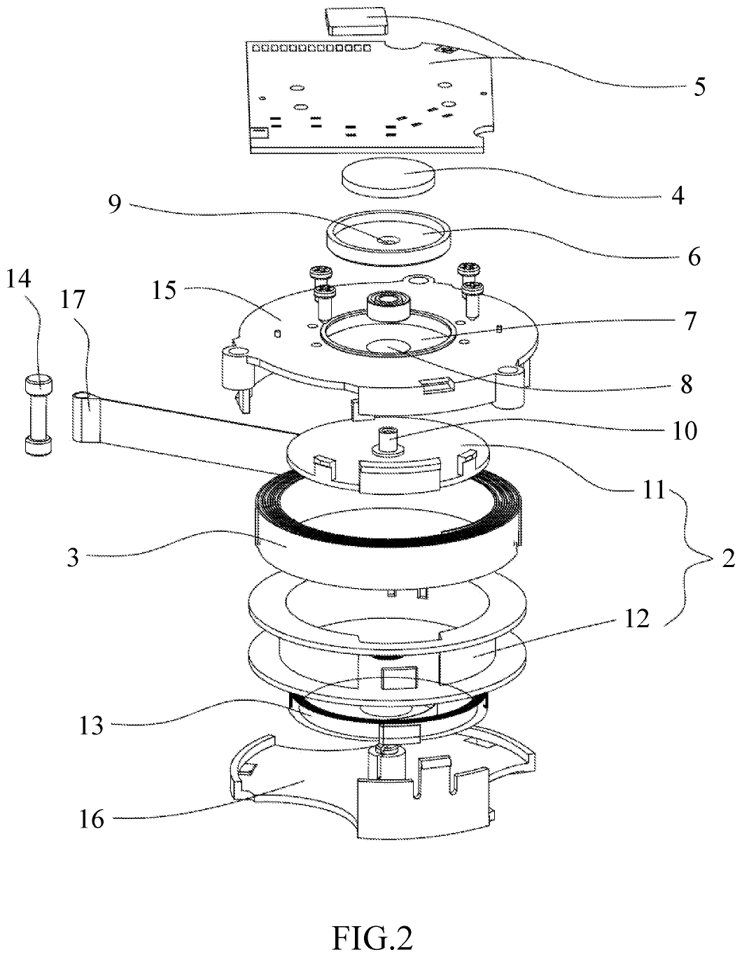

Referring to FIGS. 1 and 2, the present invention discloses a magnetic sensing electronic tape measure comprising a housing (1), a reel (2) mounted within the housing (1), and a tape (3) wound onto the reel (2). A magnet (4) is fixed on the reel (2), and a magnetic sensor module (5) capable of sensing the rotation of the magnet is provided within the housing (1). In this application, the magnetic sensor module (5) comprises a magnetic sensor and an MCU processing chip. Since both the magnetic sensor and the MCU processing chip are commonly purchased components, and the magnetic sensor is also used according to its functions, the specific structure and circuit for both are not elaborated, and to make a specific choice. The magnetic sensor is a TMR sensor, and the principle of the TMR sensor is that it forms a structure with two magnetic layers sandwiching a non-magnetic layer. The non-magnetic layer acts as the sensor's contact, and the magnetic layers allow current to pass through and generate a magnetic field. When an external magnetic field interacts with the magnetic field in the magnetic layers, the direction of the magnetic field changes, thereby changing the value of the tunnel magnetoresistance. The TMR sensor can utilize the change rate of the resistance value related to the changes in the external magnetic field to detect the strength and direction of the magnetic field, and is therefore characterized by high sensitivity and output. Other applicable magnetic sensors include an AMR, a linear magnetoresistance, etc., which can also detect changes in the magnetic field during rotation to achieve measurement functionality.

As shown in the drawings, the magnet (4) is a disc-shaped magnet (4), and the center of the magnet (4) is coaxial with the rotational center of the reel (2). The disc-shaped magnet (4) occupies no space in thickness and forms a uniform magnetic field, and the disc shape is also the shape required for the angle detection.

As shown in the drawings, the structure also comprises a mounting plate (6), with the magnet (4) fixed in the mounting plate (6) and the mounting plate (6) fixed to the reel (2). For ease of installation, the magnet (4) is fixed in the mounting plate (6) with adhesive. The housing (1) is formed with a recess (7) and an axial hole (8) communicating with the recess (7). The mounting plate (6) is located in the recess (7), and the bottom center of the mounting plate (6) has a mounting through-hole (9). The reel (2) is equipped with a rotating shaft (10) connected to the axial hole (8) through a bearing (17). The rotating shaft (10) is provided with a fixed screw hole, and a fixing screw passes through the mounting through-hole (9) and is fixed to the fixed screw hole, thereby fixing the mounting plate (6) to the rotating shaft (10). By the above structure, the mounting plate (6) and the rotating shaft (10) are fixed as one, and by sinking the recess (7) into the housing (1), the thickness of the housing (1) is reduced so that the space within the housing (1) can be effectively utilized. Moreover, there is a certain gap between the mounting plate (6) and the bearing so that the rotation of the bearing (17) is not affected, and the structure of the bearing (17) allows more sensitive rotation of the reel (2).

As shown in the drawings, for ease of manufacturing and installation, the reel (2) comprises an inner flange (11) and an outer flange (12). The rotating shaft (10) is disposed on the inner flange (11), and the inner flange (11) is disposed within a flange hole of the outer flange (12) and secured to the outer flange (12) by a snap-fit structure. The snap-fit structure is a conventional hook-and-hole mating structure and is therefore not elaborated. A spiral spring (13) is mounted in a space isolated by the inner flange (11) within the flange hole. The housing (1) comprises an upper housing (15) and a lower housing (16). Since the mounting of the spiral spring (13) is the same as the structure and mounting of the ordinary tape (3), it is not further elaborated.

As shown in the drawings, as a preferred structure, the end of the tape (3) is equipped with an end magnet (14), and the housing (1) is equipped with a Hall switch (not shown) for sensing the end magnet (14). The Hall switch is connected to the MCU processing chip, and the end magnet (14) is secured at the tape (3) exit of the outer housing (1). When the Hall switch is in this position, the Hall switch can sense the end magnet (14), causing the Hall switch to turn off and send a signal to the MCU processing chip indicating that the tape (3) is at the zero position. The correct dimension of the tape (3) pulled out after zeroing is then known. Sometimes, users may accidentally pull out the tape (3) before power on, resulting in inaccurate measurements. In such a case, the tape (3) can be retracted to zero the end magnet (14) before the tape (3) is pulled out for measurement. Moreover, with the cooperation of the end magnet (14) and the Hall switch, automatic shutdown can be achieved to save power, for instance, the screen can be set to automatically turn off a certain time after the end magnet (14) returns to zero. As a specific structure, the end magnet (14) is cylindrical and has an annular recess (7) in the center. The end of the tape (3) is rolled into a cylinder (17) that fits into the annular recess (7). The cylinder can be made by a sewing method, making the connection structure simple and easy to manufacture and assemble.

The above provides a detailed introduction to the embodiments of the magnetic sensing electronic tape measure according to the present invention. The specific examples have been used to explain the principles and implementation methods of the present invention. The description of the above embodiments is only intended to help understand the methods of the present invention and its core idea; at the same time, for those of ordinary skill in the art, there will be changes in the specific implementation methods and scope of application according to the ideas of the present invention. In summary, the contents of this specification should not be construed as limiting the present invention.

What is claimed is:

1. A magnetic sensing electronic tape measure comprising a housing, a reel mounted within the housing, and a tape wound onto the reel, characterized in that: a magnet is fixed on the reel, and a magnetic sensor module capable of sensing the rotation of the magnet is provided within the housing.

2. The magnetic sensing electronic tape measure according to claim 1, wherein the magnet is a disc-shaped magnet, and the center of the magnet is coaxial with the rotational center of the reel.

3. The magnetic sensing electronic tape measure according to claim 2, further comprising a mounting plate, with the magnet fixed in the mounting plate and the mounting plate fixed to the reel.

4. The magnetic sensing electronic tape measure according to claim 3, wherein the housing is formed with a recess and an axial hole communicating with the recess, the mounting plate is located in the recess with a mounting through-hole at the bottom center, the reel is equipped with a rotating shaft connected to the axial hole through a bearing, and the rotating shaft is provided with a fixed screw hole; a fixing screw passes through the mounting through-hole and is fixed to the fixed screw hole, thereby fixing the mounting plate to the rotating shaft.

5. The magnetic sensing electronic tape measure according to claim 4, wherein the reel comprises an inner flange and an outer flange, the rotating shaft is disposed on the inner flange, and the inner flange is disposed within a flange hole of the outer flange and secured to the outer flange by a snap-fit structure; a spiral spring is mounted in a space isolated by the inner flange within the flange hole.

6. The magnetic sensing electronic tape measure according to claim 5, wherein the housing comprises an upper housing and a lower housing.

7. The magnetic sensing electronic tape measure according to claim 1, wherein the end of the tape is equipped with an end magnet, and the housing is equipped with a Hall switch for sensing the end magnet.

8. The magnetic sensing electronic tape measure according to claim 7, wherein the end magnet is cylindrical with an annular recess in the center, the end of the tape is rolled into a cylinder, and the cylinder fits into the annular recess.
